(19) United States
(12) Patent Application Publication
(10) Pub. No.: US 2025/0314809 A1
(43) Pub. Date: Oct. 9, 2025

(54) DIFFUSER FOR A LIDAR TEST SYSTEM

(71) Applicant: Rohde & Schwarz GmbH & Co. KG, Munich (DE)

(72) Inventors: Moritz UEFFING, Munich (DE); Benedikt SIMPER, Buch am Erlbach (DE); Matthias BEER, Neubiberg (DE); Maximilian FINK, Munich (DE)

(73) Assignee: Rohde & Schwarz GmbH & Co. KG, Munich (DE)

(21) Appl. No.: 18/628,895

(22) Filed: Apr. 8, 2024

(51) Int. Cl. G02B 5/02; G01S 7/497; G02B 3/08

(52) U.S. Cl. CPC G02B 5/0278; G01S 7/497; G02B 3/08

(57) ABSTRACT

A LiDAR test system includes a deterministically structured diffuser for redistributing LiDAR light onto an image plane of the diffuser with a particular distribution, area, or pattern. The light redistribution diffuses the wide angle LiDAR light in a preferential direction. A light receiving element, such as e.g. a detector, of the test system is placed in the image plane.

### TECHNICAL FIELD

The present disclosure relates to a diffuser for a test system for a LiDAR detector and a LIDAR test system having such diffuser.

### BACKGROUND ART

In general, a LiDAR (Light Detection and Ranging) test system represents a technological platform engineered to assess, validate, and enhance the performance of LiDAR sensors (which are the device-under-test, DUT), remote distance sensors with far-reaching applications across multiple industries. LiDAR scanners leverage light or laser beams to achieve an exceptional degree of precision in measuring distances and crafting high-resolution 3D representations of the surrounding environment. LiDAR systems are designed with versatility in mind, tailored to serve an array of applications, including but not limited to autonomous vehicles, automated production processes, archaeological endeavors, aviation, surveillance, environmental monitoring and urban planning.

Characteristic features of LiDAR systems encompass multi-beam scanning capabilities, real-time data processing, and an inherent adaptability to varying environmental conditions. Notably, the optical ranging systems offer an extended reach, enabling real-time data acquisition over substantial distances, spanning several hundred meters to kilometers. This attribute renders them exceptionally well-suited for large-scale mapping initiatives and proactive obstacle detection within the context of autonomous driving. Furthermore, LiDAR systems often incorporate sophisticated software components, facilitating the comprehensive analysis of data and seamless integration with other sensor inputs.

In a noteworthy development, LiDAR test systems possess the dynamic capability to simulate the presence of moving objects, such as pedestrians and vehicles. This feature is of significant practical value, enabling a comprehensive evaluation of a LiDAR's proficiency in object detection and tracking. The intersection of precise mapping, calibration, adaptability to real-world scenarios, and advanced data processing makes this technology a pivotal asset in our modern technological landscape.

Since many typical applications of LiDAR devices require a large field of view for 3D ranging, a high possible detection angle of incidence is very desirable. The technical problem is how to increase the field of view of the LiDAR measurement with increased signal at larger incident angles in a cost-effective manner and without moving the detector or parts of the measurement setup.

### SUMMARY

Thus, there is a need to detect a wide field of view in the LiDAR ranging measurement using only few and best case static optical components. By increasing the signal at larger incidence angles on the screen of a LIDAR test system, the FOV where signals can be detected and/or targets can be simulated can be increased.

These and other objectives are achieved by the embodiments provided in the enclosed independent claims. Advantageous implementations of the embodiments of the present disclosure are further defined in the dependent claims.

According to a first aspect, the present disclosure relates to a LiDAR test system comprising:
a deterministically structured diffuser for redistributing light from a LiDAR sensor (being the DUT) onto an image plane of the diffuser with a particular distribution, area, or pattern, wherein the light redistribution diffuses the wide angle LiDAR light in a preferential direction, and
a light receiving element (e.g. detector) of the test system placed in the image plane.

A structured diffuser typically has a structured surface pattern at least at the LIDAR light receiving side.

The surface pattern typically is transparent.

The structured surface pattern may comprise a plurality of microstructures selected from the group consisting of pyramids, cones, prisms, lenses, and combinations thereof.

The diffusor, being part of the LIDAR test system, thus assists with the acquisition of a wide FOV (Field-of-view) during the LIDAR sensor test.

To this effect, the diffuser is designed to guide the (typically wide angle) light from the LIDAR sensor (being the DUT) to a specific direction/position in 3D space essentially independent of the incident angle of the LIDAR light onto the diffuser.

The structured diffusor may comprise at least one Fresnel lens configured to receive incident LiDAR light.

The diffusor may comprise a diffusor plate.

The diffusor may comprise two Fresnel lenses arranged in proximity or in contact respectively with one side of the diffusor plate.

In an implementation form of the first aspect, the light redistribution intensity profile on the LiDAR sensor is Gaussian or Flat-top or deterministic.

In an implementation form of the first aspect, the diffusor is micro- or nano-structured or perforated for diffusing LiDAR light.

In an implementation form of the third aspect, the diffusor is structured e.g. by lithographic fabrication or by ultraprecision milling. Other possible techniques are photolithography, laser ablation, embossing, and injection molding.

For example, the fabrication may be based on grayscale lithography for structuring a polymer film on a transparent substrate. Standard optical substrates such as glass materials can be used for that.

Following another example, the fabrication steps comprise lithographically defining an etch mask and then etching the structure into fused Silica, Silicon or Germanium. A hard etched optical material is advantageous for operation in rough environments, i.e. where the detector needs to withstand dust, dirt or water or needs to be cleaned frequently.

In an implementation form of the first aspect, the full angle of incidence is between 0° and at least ±50°, preferably at least ±55° or even ±60°.

Preferably the processing of the incoming LIDAR light in the LIDR test system is optical, comprising e.g. one or more of optical delay, attenuation and amplification. Alternatively or additionally the processing may comprise an electronic delay.

According to second aspect, the present disclosure relates to a LiDAR test system with as a delay circuit, at least one LiDAR tester, a controller and a test environment.

In an implementation form of the second aspect, the controller comprises a processor and a memory for real-time data analysis, timing, synchronization and feedback capabilities.

### BRIEF DESCRIPTION OF THE DRAWINGS

The above described aspects and implementation forms of the present disclosure will be explained in the following description of specific embodiments in relation to the enclosed drawings, in which:

FIG. 1 shows a schematic of a LiDAR tester (detector) with a structured diffuser;

FIG. 2 shows a schematic of a LiDAR test system;

FIG. 3 shows the LiDAR beam path with angular and tilt redistribution;

FIG. 4 shows LiDAR light intensity redistribution; and

FIG. 5. shows a structured diffuser with Fresnel lenses.

### DETAILED DESCRIPTIONS OF EMBODIMENTS

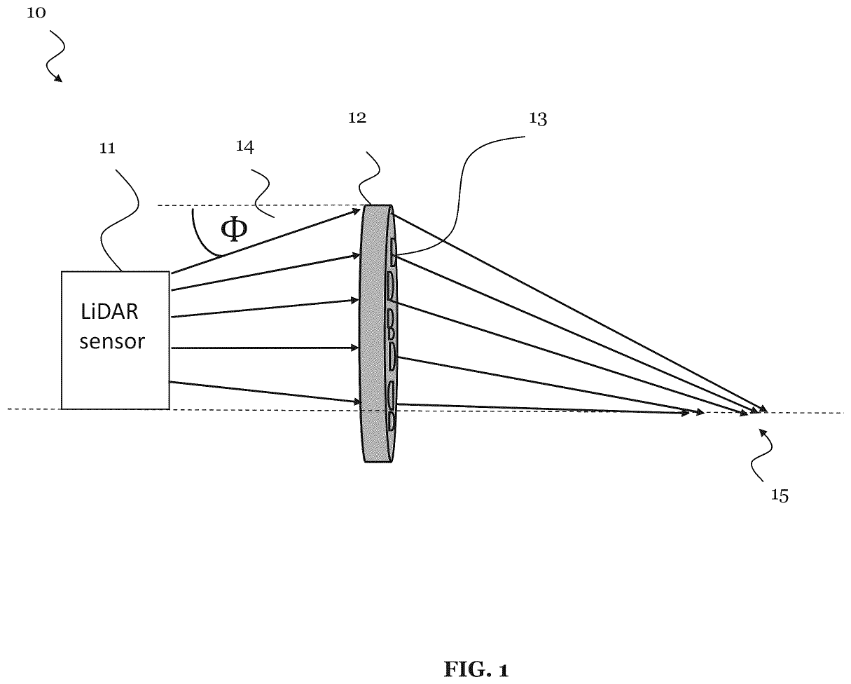

FIG. 1 shows a schematic of a LiDAR test system 10, with a LiDAR sensor 11 as DUT and a structured diffuser 12, being part of the LIDAR tester. The diffusor 12 may present a micro- or nano-structured optical surface 13, which diffuses the incoming LiDAR light from the LIDAR sensor 11 to a specific direction/position in 3D space essentially independent of the incident angle of the LIDAR light 14 onto the diffuser 12 towards at least one preferential location in the image plane 15.

The structured diffusor may have the shape of a plate.

FIG. 1 shows the diffuser 12 being distanced from the LiDAR sensor 11, e.g. in a distance between 30 cm and 2 m. The structured diffuser 12 is part of the tester 23.

The structured diffuser 12 may be mounted in front of the light receiving element of the tester 23.

The angle of incidence @ of the LiDAR light 14 is preferably ranging from at least ±50°, more preferably at least ±55° or even ±60°. In a most preferred example, the angle of incidence 14 is ranging from at least ±60°. Preferably, the structured diffuser 12 is at least slightly larger than the horizontal and vertical dimension of the footprint of the addressed FOV in the diffuser plane, for example few millimeters to few centimeters.

According to one embodiment the structured diffusor 12 can be a material compound consisting for instance out of a transparent substrate such as glass and a micro-structured polymer coating.

The structured diffusor 12 can be produced by lithographically defining and developing the polymer resist on top of the substrate or by directly nano-imprinting the desired structure into the polymer film. The polymer resist layer is preferably several microns up to hundreds of microns thick. In another embodiment the diffuser 12 can be a mono-bloc of a hard optical material such as silicon, germanium or silica and the like where the structure is etched into the surface of the substrate to structure the diffuser 12.

Preferably, the etch into the surface is several microns down to hundreds of microns deep. Most preferable, the etch is several tens of microns deep.

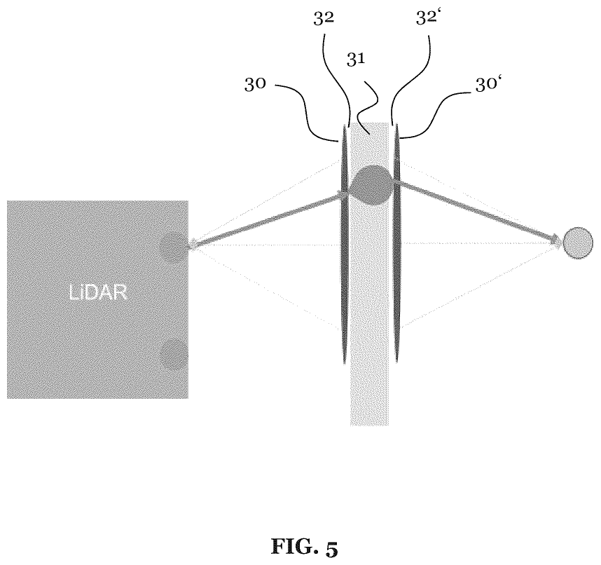

The diffuser 12 may also consist of multiple elements. For example, the diffusor 12 may comprise or consist of Fresnel lenses 30, 30′, see FIG. 5, in combination with a diffuser 31. The Fresnel lenses. There may be a spacing between these elements of the multiple element diffusor 12.

As shown, the Fresnel lenses 30, 30′ may be preferably provided at each side of the diffusor 12. At least one or more of the Fresnel lenses 30. 30′ may be spaced from the diffusor, preferably by an air gap.

Each Fresnel lens preferably comprises a plurality of concentric grooves formed on a surface thereof.

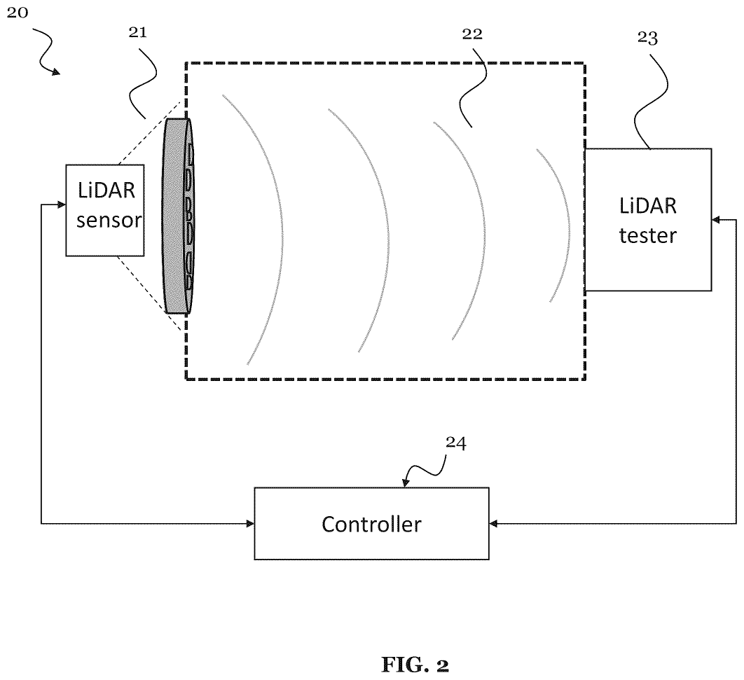

FIG. 2 shows a schematic of a LiDAR system 20 with LiDAR sensor 21, a LiDAR tester 23 and a controller 24. The controller 24 is connected to LiDAR sensor 21, and the LIDAR tester 23 for processing data, optionally synchronizing and controlling the measurement and providing feedback.

Thus, the light path is from the diffuser 12 through free-space propagation after the diffuser (typically over a length of a few cm) to the light receiving element of the LiDAR tester 23.

In an embodiment of this LiDAR test system 20, the tester 21 can replay delayed or modulated signals to simulate an application where the LiDAR sensor 21 is stationary and targets are moved relatively. According to this embodiment, it is important to extent the field of view of the LiDAR measurement to achieve a wider, more extended, or even dynamic ranging measurement. In another example of the LiDAR test system 20, targets in the test environment 22 are translated or are emulated to be moved to simulate a traffic or environmental monitoring application with moving objects.

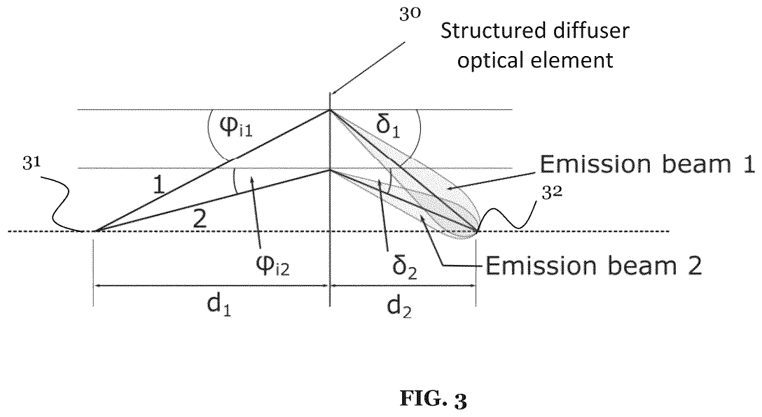

FIG. 3 shows the beam path of LiDAR light, with incoming beams 31 from the LIDAR sensor, the structured diffuser as optical element 30, the beams hitting the LIDAR tester 32 with the corresponding angular redistribution and tilt. The incoming beams 1 and 2 hit the structured diffuser at distance d1 with angles φi1 and 100 i2. The emission beams hit the target/detector, i.e. light receiving element of the tester, at distance d2 with corresponding to angles δ1 and δ2.

FIG. 3 specifically shows how the structured diffuser 30 directs the LiDAR light in a preferential direction towards the detector and how it changes the tilt angle of the incoming beams and the outgoing beams. Preferably, the distances d1 and d2 typically ranges from mm to few cm, for example between 1 and 25 cm, preferably 3 to 20 cm, most preferred 5 to 15 cm.

The angles 100 i1 and 100 i2 of the incoming LiDAR light can preferably range from ±60°. Preferably, the angles δ1 and δ2 of the outgoing LiDAR beams are locally defined by the micro-structure of the optical diffuser and can preferably range from ±60°, whereas the outgoing angles δ1 and δ2 preferentially direct the light towards the sensor 11, which means that the outgoing angles are preferentially smaller than the incoming angles.

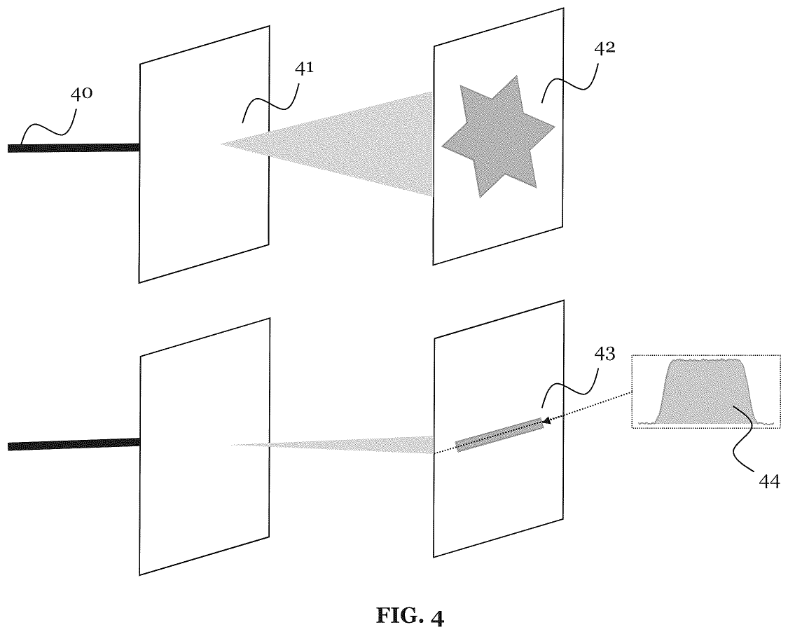

FIG. 4 shows the LiDAR light intensity redistribution, where the incoming LiDAR beam 40 is hitting the structured diffuser 41. From the structured diffuser the LiDAR light beam is preferentially directed towards the sensor 11 showing a star shaped intensity pattern on the image plane 42. In the lower part of the figure the LiDAR beam diffused onto the image plane shows another possible pattern a line-shaped profile 43 with a flat-top intensity distribution shown as profile cut line in the dashed inset 44.

FIG. 4 explicitly shows non-spherical, non-elliptical, such as star-shaped 42, and non-Gaussian, i.e. flat-top 44, intensity distributions. These special distributions are not achievable with standard diffusers, i.e. ground glass based diffusers, or single linear optical components, i.e. standard lenses.

Moreover, a use of apertures to allow only specific illumination areas on the LiDAR sensor 11 instead of a structured diffuser degrades the LiDAR signal intensity and decreases the possible maximum angle of incidence. Hence, the use of a micro-structured diffuser element also renders the LiDAR detector compact and cost-efficient compared to other optical device solutions. The specific intensity distributions and shapes are not governed by paraxial systems calculated by non-complex linear algebra such as the standard ABCD matrix law.

Preferentially, the structured diffuser properties are calculated using iterative Fourier-Transform algorithm for a given far field light distribution on the LiDAR sensor 11. In the most preferred example, each patterned submicron sized spot on the structured diffuser solves the optical problem point-by-point in the sense of backward and forward Fourier transform to create a completely deterministic pattern on the sensor image plane.

All features explained in connection with individual embodiments of the present disclosure may be implemented in different combinations in the subject-matter according to the invention in order to simultaneously realize their advantageous effect. The scope of protection of the present disclosure is given by the patent claims and is therefore not limited by the features explained in the description or shown in the figures.

1. A LiDAR test system comprising:
a deterministically structured diffuser for redistributing LiDAR light onto an image plane of the diffuser with a particular distribution, area, or pattern,
wherein the light redistribution diffuses the wide angle LiDAR light in a preferential direction, and
a light receiving element, such as e.g. a detector, of the test system placed in the image plane.

2. The test system according to claim 1, wherein the structured diffusor comprises at least one Fresnel lens configured to receive incident LiDAR light.

3. The test system of claim 2,
wherein the diffusor comprises a diffusor plate.

4. The test system of claim 3,
wherein the diffusor comprises two Fresnel lenses, each of them respectively arranged in proximity or in contact respectively with one side of the diffusor plate.

5. The test system according to claim 1, wherein the light redistribution intensity profile on the LiDAR sensor is Gaussian or Flat-top or deterministic.

6. The test system according to claim 1, wherein the diffusor is micro- or nano-structured for diffusing LiDAR light.

7. The test system according to claim 6, wherein the diffusor is structured by lithographic fabrication and/or by ultra-precision machining/milling.

8. The test system according to claim 1, wherein the full angle of incidence is between 0° and at least ±50°, preferably at least 55° or even ±60°.

9. The test system according to claim 1, wherein the light redistribution of the LiDAR light towards the image plane has a locally variable angular distribution or tilt function.

10. A LiDAR test system comprising the LiDAR detector according to claim 1 as well as a LiDAR light emitting sensor.

11. LiDAR test system of claim 10, further comprising a controller having a processor and a memory for real-time data analysis, timing, optionally synchronization and feedback capabilities.
